(19) United States
(12) Patent Application Publication
(10) Pub. No.: US 2025/0266592 A1
(43) Pub. Date: Aug. 21, 2025

(54) SECONDARY BATTERY WITH BUFFERS AND METHOD OF MANUFACTURING THE SAME

(71) Applicant: SAMSUNG SDI CO., LTD., Yongin-si (KR)

(72) Inventors: Soomin Baek, Yongin-si (KR); Hojun Shin, Yongin-si (KR); Sangwon Kim, Yongin-si (KR); Yeonho Jung, Yongin-si (KR)

(21) Appl. No.: 18/763,691

(22) Filed: Jul. 3, 2024

(30) Foreign Application Priority Data
Feb. 21, 2024 (KR) 10-2024-0025227

(51) Int. Cl. H01M 50/586; H01M 10/04; H01M 50/103; H01M 50/474; H01M 50/477; H01M 50/486; H01M 50/595

(52) U.S. Cl. CPC H01M 50/586; H01M 10/049; H01M 50/103; H01M 50/474; H01M 50/477; H01M 50/486; H01M 50/595; H01M 2220/20

(57) ABSTRACT

A secondary battery includes: an electrode assembly; a case accommodating the electrode assembly therein; and a buffer arranged between the electrode assembly and the case and repeatedly bent a plurality of times.

### CROSS-REFERENCE TO RELATED APPLICATION

The present application claims priority to and the benefit of Korean Patent Application No. 10-2024-0025227, filed on Feb. 21, 2024, in the Korean Intellectual Property Office, the entire disclosure of which is incorporated herein by reference.

### BACKGROUND

### 1. Field

Aspects of embodiments of the present disclosure relate to a secondary battery and manufacturing method thereof.

### 2. Description of the Related Art

Different from primary batteries, which are not designed to be (re) charged, secondary batteries are designed to be discharged and recharged. Low-capacity secondary batteries are used in small portable electronic devices, such as smart phones, feature phones, notebook computers, digital cameras, and camcorders, while large-capacity secondary batteries are widely used as power sources for driving motors, such as for hybrid vehicles or electric vehicles, and for power storage (e.g., home and utility scale power storage).

Generally, a secondary battery includes an electrode assembly including a positive electrode and a negative electrode, a case accommodating the electrode assembly, a terminal connected to the electrode assembly, a cap plate assembled to the case and equipped with the terminal, and the like. An insulator is interposed between an inner side of the case and the electrode assembly to provide electrical insulation. This insulator is called (or is referred to as) a side retainer because it is located between a side of the electrode assembly and the inner surface of the case facing the same in the secondary battery and performs a supporting function in addition to an insulating function.

The above information disclosed in this Background section is for enhancement of understanding of the background of the present disclosure, and therefore, it may contain information that does not constitute related (or prior) art.

### SUMMARY

With a rising demand for large cells for electric vehicles and large-capacity energy storage systems (ESS), there is a desire to enhance the shock-absorbing function (or ability) of a secondary battery to protect the electrode plate of the electrode assembly thereof against shock or vibration that may be applied to the case.

Accordingly, embodiments of the present disclosure provide a buffer configured to fill an insert gap between each short side of a case and a side of an electrode assembly corresponding thereto to absorb shock and vibration transmitted through the case from the outside, and a secondary battery employing the same.

According to an embodiment of the present disclosure, a secondary battery includes an electrode assembly, a case accommodating the electrode assembly therein, and a buffer arranged between the electrode assembly and the case and repeatedly bent a plurality of (e.g., multiple) times.

In some embodiments, the buffer may include a first buffer arranged in a first insert gap between a first short side of the case and the electrode assembly and a second buffer arranged in a second insert gap between a second short side of the case and the electrode assembly.

In some embodiments, the buffer may be part of an internal insulation tape that is wrapped around the electrode assembly.

According to another embodiment of the present disclosure, a method of manufacturing a secondary battery includes forming a buffer by repeatedly bending a non-conductive material a plurality of times and inserting an electrode assembly into a case and arranging the buffer in an insert gap between an inner surface of a short side of the case and an opposing surface of the electrode assembly.

According to another embodiment of the present disclosure, an internal insulation tape for secondary batteries that is configured to be wrapped around an electrode assembly and accommodated in a case of a secondary battery and includes a buffer arranged between the electrode assembly and the case and repeatedly bent a plurality of times.

Aspects and features of the present disclosure are not limited to those described above, and other aspects and features not specifically mentioned herein will be clearly understood by those skilled in the art from the description of the present disclosure below.

### BRIEF DESCRIPTION OF THE DRAWINGS

The following drawings attached to the present specification illustrate embodiments of the present disclosure and further describe aspects and features of the present disclosure together with the detailed description of the present disclosure. Thus, the present disclosure should not be construed as being limited to the drawings, in which:

FIG. 1 is a top perspective view of a prismatic secondary battery according to some embodiments of the present disclosure;

FIG. 2 is a cross-sectional view taken along the line I-I′ in FIG. 1 according to some embodiments of the present disclosure;

FIG. 3 is an exploded perspective view of the prismatic secondary battery shown in FIGS. 1 and 2 according to some embodiments of the present disclosure;

FIG. 4 is a transverse cross-sectional view taken along the line II-II′ in FIG. 3;

FIG. 5 illustrates a swelled electrode assembly due to charging during use of the secondary battery illustrated in FIG. 4;

FIG. 6 is a transverse cross-sectional view of a secondary battery according to some embodiments of the present disclosure;

FIG. 7 is a longitudinal cross-sectional view of a secondary battery according to some embodiments of the present disclosure;

FIG. 8 is a plan view of an internal insulation tape including a buffer according to some embodiments of the present disclosure;

FIG. 9 is a schematic view illustrating a state in which the insulation tape shown in FIG. 8 is applied to the electrode assembly;

FIG. 10 is a plan view of an internal insulation tape including a buffer according to other embodiments of the present disclosure;

FIG. 11 is a schematic view illustrating a state in which the insulation tape shown in FIG. 10 is applied to the electrode assembly;

FIG. 12 is a plan view of an internal insulation tape including a buffer according to other embodiments of the present disclosure;

FIGS. 13A and 13B are schematic views illustrating a state in which the insulation tape shown in FIG. 12 is applied to the electrode assembly;

FIG. 14 is a perspective view of a secondary battery module in which secondary batteries are arranged according to some embodiments of the present disclosure;

FIG. 15 is a perspective view of a secondary battery pack including the secondary battery module shown in FIG. 14; and

FIG. 16 is a schematic view of a vehicle equipped with the secondary battery pack shown in FIG. 15.

### DETAILED DESCRIPTION

Hereinafter, some embodiments of the present disclosure will be described with reference to the accompanying drawings. Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification and should not be interpreted in an idealized or overly formal sense unless expressly so defined herein.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element and another element may also be interposed between the element and the arbitrary element disposed on (or under) the element.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

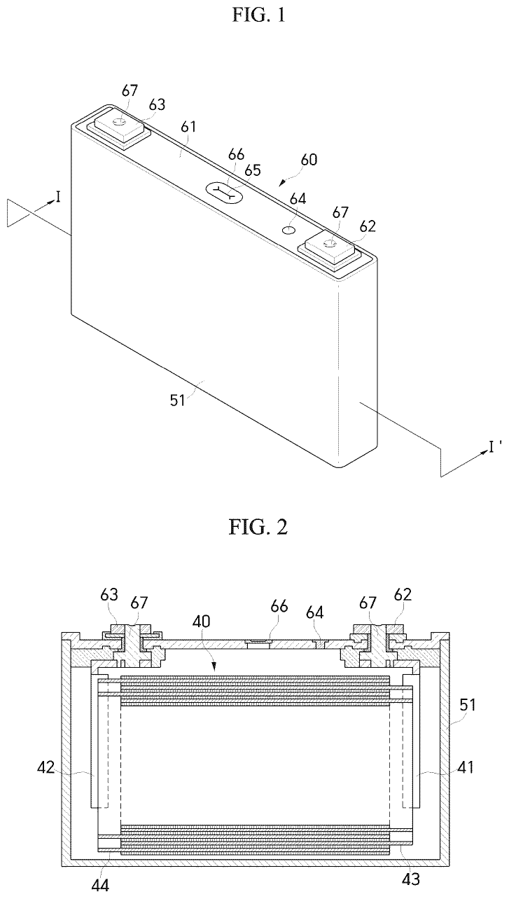

FIG. 1 is a top perspective view of a prismatic secondary battery according to some embodiments of the present disclosure, and FIG. 2 is a cross-sectional view taken along the line I-I′ in FIG. 1 according to some embodiments of the present disclosure.

First, the external appearance of the prismatic secondary battery illustrated in FIG. 1 will be described.

A case 51 defines (or defines) an overall appearance of the prismatic secondary battery and may be made of a conductive metal, such as aluminum, aluminum alloy, or nickel-plated steel. In addition, the case 51 may provide a space for accommodating an electrode assembly therein.

A cap assembly 60 may include a cap plate 61 that covers an opening in the case 51. In some embodiments, the case 51 and the cap plate 61 may be made of a conductive material (e.g., may be made of the same conductive material). A first terminal 62 and a second terminal 63 may be electrically connected to respective positive and negative (or negative and positive) electrodes inside the case and may be installed to protrude outwardly through the cap plate 61.

The cap plate 61 may have an electrolyte injection port 64 in which a sealing plug (or seal pin) may be installed and a vent 66 having with a notch 65. The vent 66 is for discharging gas generated inside the secondary battery.

With reference to FIG. 2, the internal structure of the prismatic secondary battery and the coupling structure with the cap assembly 60 will be further described.

As shown in FIG. 2, a prismatic secondary battery may include an electrode assembly 40, a first current collector 41, a first terminal 62, a second current collector 42, a second terminal 63, the case 51, and the cap assembly 60.

An electrode assembly 40 may be formed by winding or stacking a stack of a first electrode plate, a separator, and a second electrode plate, which are formed as thin plates or films. When the electrode assembly 40 is a wound stack, a winding axis may be parallel to the longitudinal direction of the case 51. In some other embodiments, the electrode assembly 40 is a stack type rather than a winding type, and the shape of the electrode assembly 40 is not limited in the present disclosure. In addition, the electrode assembly 40 may be a Z-stack electrode assembly in which a positive electrode plate and a negative electrode plate are inserted into both sides of a separator, which is then bent into a Z-stack. In addition, one or more electrode assemblies may be stacked such that long sides of the electrode assemblies are adjacent to each other and accommodated in the case, and the number of electrode assemblies in the case is not limited in the present disclosure. The first electrode plate of the electrode assembly may act as a negative electrode, and the second electrode plate may act as a positive electrode. Of course, the reverse is also possible.

The first electrode plate may be formed by applying a first electrode active material, such as graphite, carbon, or the like, to a first electrode current collector formed of a metal foil, such as copper, a copper alloy, nickel, a nickel alloy, or the like.

The first electrode plate may include a first electrode tab 43 (e.g., a first uncoated portion), which is a region to which the first electrode active material is not applied. The first electrode tab 43 may act as a current flow path between the first electrode plate and the first current collector 41. In some embodiments, when the first electrode plate is manufactured, the first electrode tab 43 is formed by being cut in advance to protrude to one side of the electrode assembly 40, or the first electrode tab 43 may protrude to one side of the electrode assembly 40 more than (e.g., farther than or beyond) the separator without being separately cut.

The second electrode plate may be formed by applying a second electrode active material, such as a transition metal oxide, on a second electrode current collector formed of a metal foil, such as aluminum or an aluminum alloy. The second electrode plate may include a second electrode tab 44 (e.g., a second uncoated portion), which is a region to which the second electrode active material is not applied. The second electrode tab 44 may act as a current flow path between the second electrode plate and the second current collector 42. In some embodiments, the second electrode tab 44 may be formed by being cut in advance to protrude to the other side (e.g., the opposite side) of the electrode assembly when the second electrode plate is manufactured, or the second electrode plate may protrude to the other side of the electrode assembly more than (e.g., farther than or beyond) the separator without being separately cut.

In some embodiments, the first electrode tab 43 is located on the left side of the electrode assembly 40, and the second electrode tab 44 may be located on the right side of the electrode assembly 40. In some other embodiments, the first electrode tab 43 and the second electrode tab 44 are located on one side of the electrode assembly 40 in the same direction. Here, for convenience of description, the left and right sides are defined according to the secondary battery as oriented in FIG. 1, and the positions thereof may change when the secondary battery is rotated left and right or up and down.

The separator prevents or substantially reduces instances of a short circuit between the first electrode plate and the second electrode plate while allowing movement of lithium ions therebetween. The separator may be made of, for example, a polyethylene film, a polypropylene film, a polyethylene-polypropylene film, or the like.

The first electrode tab 43 of the first electrode plate and the second electrode tab 44 of the second electrode plate may be positioned at both ends (e.g., opposite ends) of the electrode assembly 40. In some embodiments, the electrode assembly 40 is accommodated in the case 10 along with an electrolyte. In addition, in the electrode assembly 40, the first current collector 41 and the second current collector 42 may be welded and connected to the first electrode tab 43 of the first electrode plate and the second electrode tab 44 of the second electrode plate exposed on both sides, respectively, to then be positioned thereat, respectively.

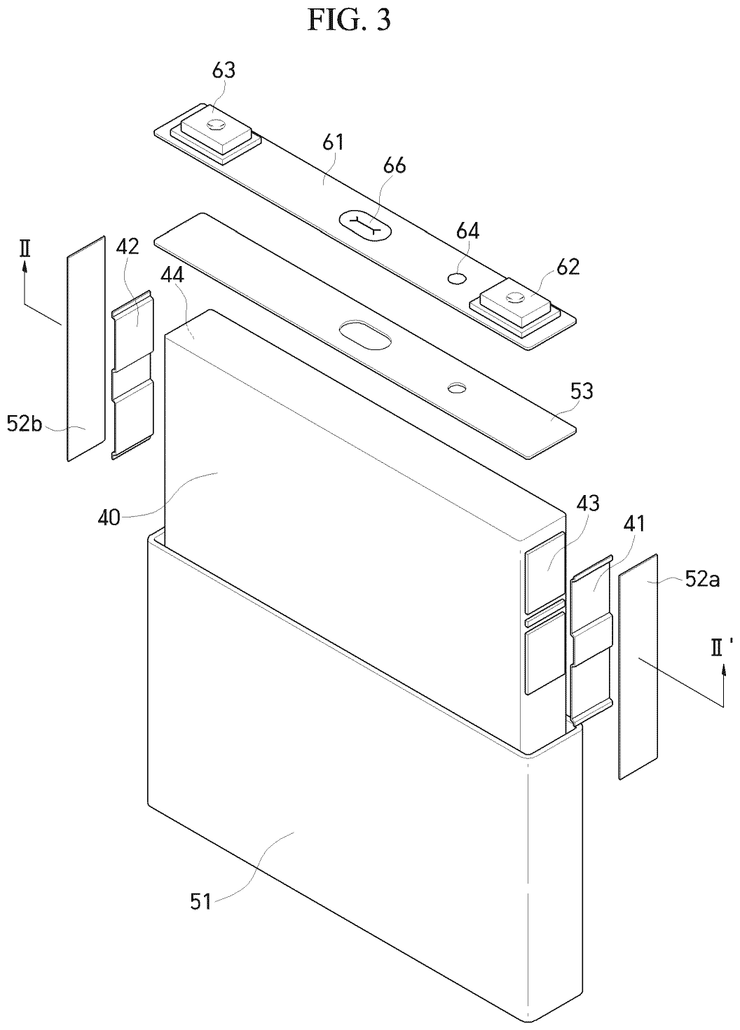

FIG. 3 is a schematic exploded perspective view of the prismatic secondary battery shown in FIGS. 1 and 2 according to some embodiments of the present disclosure.

The electrode assembly 40 that is inserted into the case 51, and the cap plate 61 that covers the top of the case 51, are illustrated in the cross-sectional view of FIG. 2. FIG. 3 illustrates the first current collector 41 and the second current collector 42 in a disassembled (or exploded) view. As described above, the first current collector 41 and the second current collector 42 may electrically connect the first electrode tab 43 and the second electrode tab 44, which are exposed to both sides of the electrode assembly 40, to the first terminal 62 and the second terminal 63, respectively.

In the prismatic secondary battery, insulators may be arranged on the upper and lower surfaces and left and right sides of the electrode assembly 40 to electrically insulate the electrode assembly 40 from the cap plate 61 and the case 51.

For example, an upper insulator 53 may be interposed between the upper surface of the electrode assembly 40 and the cap plate 61, and a lower insulator may be interposed between the lower surface of the electrode assembly 40 and the inner underside of the case 51.

In addition, side insulators (e.g., a right side insulator 52a and a left side insulator 52b) may be interposed between the left and right sides of the electrode assembly 40 and the inner opposing surfaces of the case 51, respectively. The side insulators 52a and 52b are called side retainers because they also act as supports and shock absorbers between the case 51 and the electrode assembly 40. The upper ends of the respective side retainers may be supported by connection to both ends of the upper insulator 53 through hooking, projection insertion, or the like.

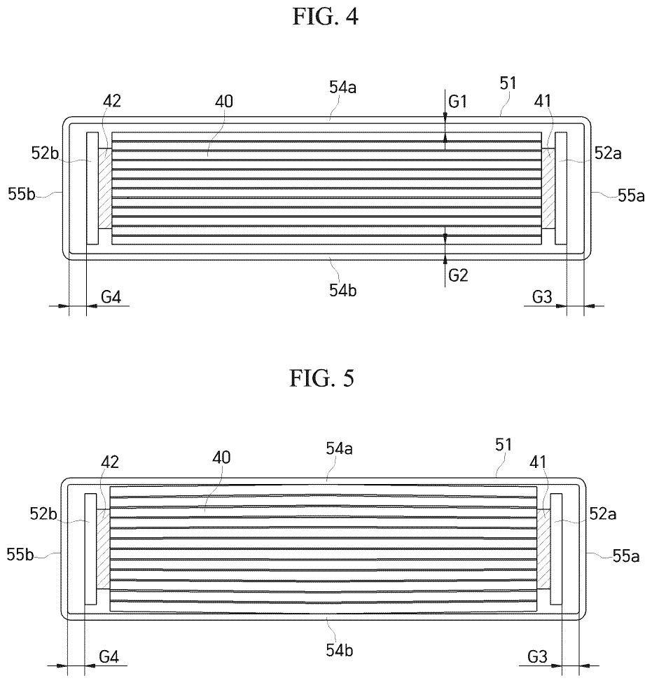

FIG. 4 is a transverse cross-sectional view taken along the line II-II′ in FIG. 3.

The case 51 may have a rectangular shape in a transverse cross-section, which may be composed of opposing first and second long sides 54a and 54b and opposing first and second short sides 55a and 55b. The electrode assembly 40 is accommodated inside the case 51. As mentioned previously in the description of FIG. 3, the electrode assembly 40 may be accommodated in the case 51 such that the first current collector 41 and the second current collector 42 are bonded to the respective sides of the electrode assembly 40 and are in contact with the first short side 55a and the second short side 55b of the case 51 through the first side retainer 52a and the second side retainer 52b, respectively.

To easily insert the electrode assembly 40 into the internal space of the case 51 when manufacturing the secondary battery, an insert gap may be provided between the electrode assembly 40 and each opposing surface of the case 51. For example, as illustrated in FIG. 4, an insert gap G1 may be established between the inner surface of the first long side 54a and the opposing surface of the electrode assembly 40, an insert gap G2 may be established between the inner surface of the second long side 54b and the opposing surface of the electrode assembly 40, an insert gap G3 may be established between the inner surface of the first short side 55a and the opposing surface of the electrode assembly 40, and an insert gap G4 may be established between the inner surface of the second short side 55b and the opposing surface of the electrode assembly 40.

FIG. 5 illustrates the electrode assembly 40 in an expanded (or swelled) state due to charging during use of the secondary battery illustrated in FIG. 4. The swelling occurs primarily on the wide faces of the electrode assembly 40 due to the plate winding or stacking structure thereof. Hence, the insert gaps G1 and G2 adjacent to the wide faces may disappear (e.g., may be filled by the electrode assembly 40), but the insert gaps G3 and G4 adjacent the narrow faces may remain almost the same.

As such, because the wide faces of the electrode assembly 40 are in close contact with the inner surfaces of both long sides 54a and 55b of the case 51 when the secondary battery is used, the secondary battery may be less affected by external vibration or shock. On the other hand, the secondary battery may not completely absorb external shock and vibration because the insert gaps G3 and G4 on the narrow faces remain open (or unfilled).

Although the side retainers 52a and 52b are included to support the sides of the electrode assembly 40, such conventional side retainers may not provide sufficient shock-absorbing ability other than insulation because they are each only about 0.2 mm thick. Further, a side retainer used commonly may be made in the form of a solid from a polymer material by injection molding and may block a path for gas discharge to the vent 66 by melting in case of events such as heat generation, gas generation, or explosion. Blockage of the path for gas discharge may become more severe, especially in a battery with a vent formed at a bottom of the case 51, different from the battery shown in FIGS. 2 and 3, because, when the side retainer, which is made in the form of a solid with a relatively large amount of polymer material, is melted, the resulting material is collected by gravity toward the vent at the bottom.

With a rising demand for large cells for electric vehicles and large-capacity energy storage systems (ESSs), there is an increasing desire to protect the electrode assembly by absorbing shock or vibration applied to the case.

Hereinafter, a secondary battery with an enhanced shock-absorbing function according to embodiments of the present disclosure will be described.

The secondary battery, according to embodiments the present disclosure, uses a buffer configured to fill an insert gap between an inner surface of each short side of a case and an opposing surface of an electrode assembly to absorb shock and vibration transmitted toward the electrode assembly through the case from the outside.

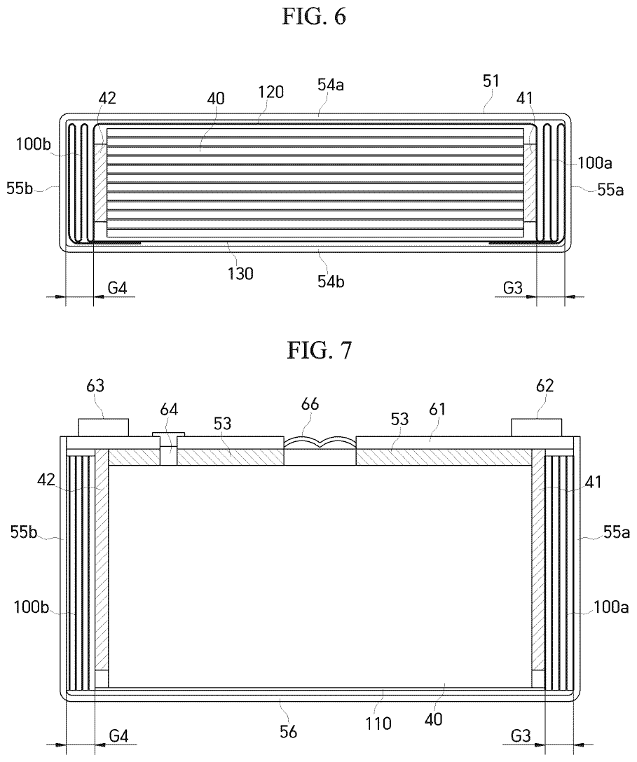

FIG. 6 is a transverse cross-sectional view of a secondary battery according to some embodiments of the present disclosure. FIG. 7 is a longitudinal cross-sectional view of the secondary battery shown in FIG. 6. FIGS. 6 and 7 illustrate that a first buffer 100a fills an insert gap G3 between a first short side 55a of a case 51 and a first current collector 41 of an electrode assembly 40. In addition, FIGS. 6 and 7 illustrate that a second buffer 100b fills an insert gap G4 between a second short side 55b of the case 51 and a second current collector 42 of the electrode assembly 40.

In some embodiments, the first buffer 100a and the second buffer 100b are each an independent member and may be inserted between the electrode assembly 40 and the inner opposing surfaces of the case 51. In such an embodiment, the first buffer 100a and the second buffer 100b may each be bent into a wrinkled (or corrugated) shape to exhibit a shock-absorbing function. The number of bending times of each of the first and second buffers 100a and 100b may depend on the distance between each side of the electrode assembly 40 (e.g., each current collector 41 or 42) and the short side 55a or 55b of the case 51 corresponding thereto, the thickness of the associated buffer, the width of an associated one of the short sides 55a and 55b of the case 51, and so on.

The first buffer 100a and the second buffer 100b include (or are made of) a non-conductive material. Examples of the non-conductive material may include a film, a plate, a woven fabric, and a non-woven fabric, made of polymer material, such as PP, PI, or PC, synthetic resin, paper, or synthetic/natural fiber. Moreover, the first buffer 100a and the second buffer 100b may be made of a non-conductive material with additional elasticity, which increases a shock-absorbing ability by adding the elasticity of the material itself to the cushioning force of the buffer caused by bending multiple times.

For example, the first buffer 100a and/or the second buffer 100b may have an adhesive applied to some surfaces thereof to be adhered to the outer surface of the electrode assembly 40. For example, after the electrode assembly 40 is manufactured by winding or stacking a positive electrode plate, a negative electrode plate, and a separator, the electrode assembly 40 may be inserted into the case 51 with the first buffer 100a and the second buffer 100b adhered to the sides (e.g., the sides to which the current collectors 41 and 42 shown in FIGS. 2 and 3 are bonded) of the electrode assembly 40. As another example, the first buffer 100a and the second buffer 100b may be in contact with the outer surface of the electrode assembly 40 without application of adhesive thereto. In such an embodiment, after the electrode assembly 40 is manufactured by winding or stacking a positive electrode plate, a negative electrode plate, and a separator, the electrode assembly 40 may be inserted into the case 51 together with the first buffer 100a and the second buffer 100b. In other embodiments, the electrode assembly 40 may first be inserted into the case 51, and then, the first buffer 100a and the second buffer 100b may be fitted into the space separated apart from the case 51.

In some other embodiments, the first buffer 100a and the second buffer 100b may be elements included in an internal insulation tape that is accommodated in the case 51 while wrapping the outer surface of the electrode assembly 40. The first buffer 100a and the second buffer 100b may each have a wrinkled shape as illustrated in FIGS. 6 and 7 by bending a portion of the internal insulation tape several times.

The internal insulation tape may be a member that wraps around and insulates the electrode assembly 40 before it is inserted into the case 51. The internal insulation tape may include parts 120 and 130 that are in contact with the faces (e.g., the wide faces in FIG. 6) of the electrode assembly 40 facing the inner surfaces of the first long side 54a and the second long side 54b of the case 51, in addition to the first buffer 100a and the second buffer 100b. As illustrated in FIG. 7, the internal insulation tape may also include a part 110 in contact with the lower surface of the electrode assembly 40 facing the inner surface of a bottom 56 of the case 51. The parts 120, 130, and 110 may all be included in a single internal insulation tape (e.g., may be parts of an integral insulation tape) or may be partially included in individual internal insulation tapes.

In this embodiment, the first buffer 100a and the second buffer 100b may be part of the internal insulation tape and may be located on the narrow faces (e.g., the sides in FIG. 6) of the electrode assembly 40 to absorb vibration and shock from the case 51 while also insulating the first and second short sides 55a and 55b of the case 51 from the electrode assembly 40. Different from conventional side retainers that were made in the form of a solid from polymer or synthetic resin materials, the buffers 100a and 100b, which are formed by bending a plate (or tape) made of a relatively small amount of material, can ensure additional safety because the buffers do not block a flow path of gas even if they melt or burn in case of a secondary battery event.

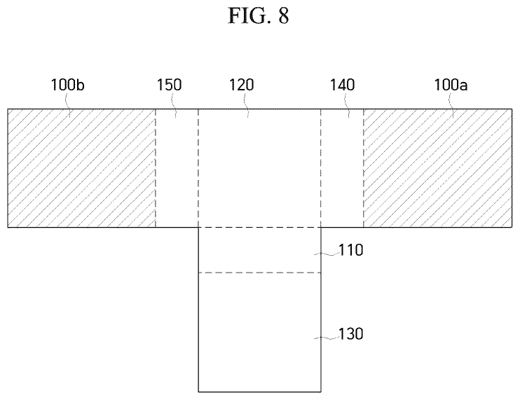

FIGS. 8 to 13B are views illustrating various shapes of an internal insulation tape including a buffer and schematic views illustrating a state in which each shaped insulation tape is applied to the electrode assembly according to various embodiments of the present disclosure.

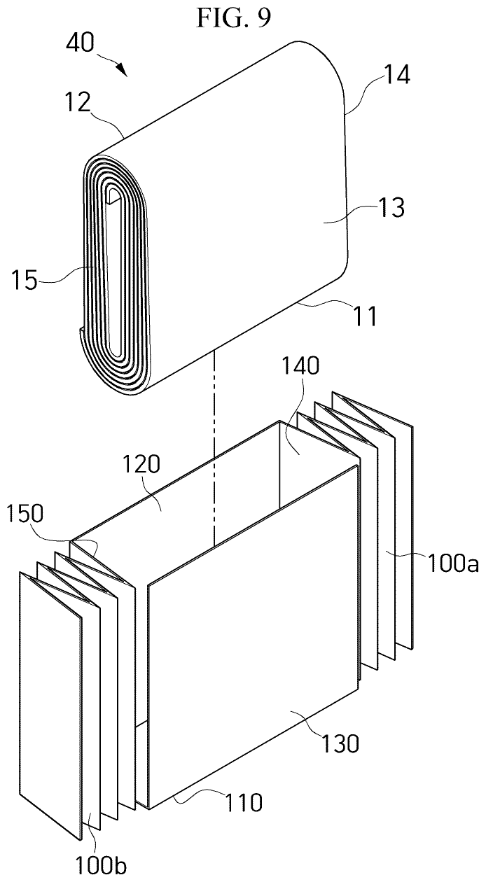

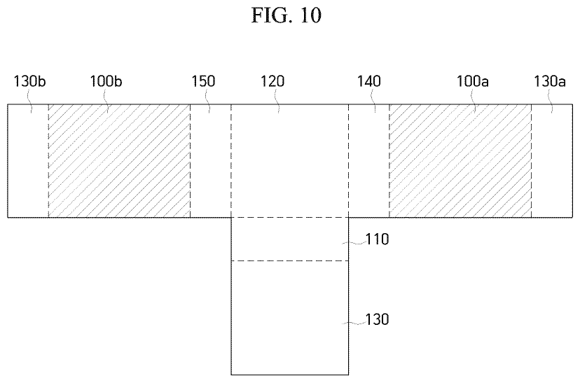

Prior to description of the various embodiments, the faces of the electrode assembly 40 shown in FIGS. 9, 11, and 13b are defined as follows: 11: first face of electrode assembly 40 (bottom in the figures); 12: second face of electrode assembly 40 (reverse side in the figures); 13: third face of electrode assembly 40 (front side in the figures); 14: fourth face of electrode assembly 40 (right side in the figures); and 15: fifth face of electrode assembly 40 (left side in the figures).

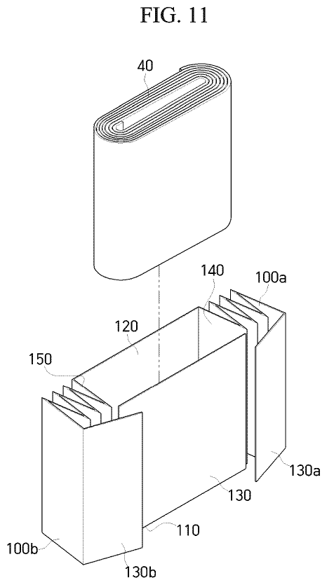

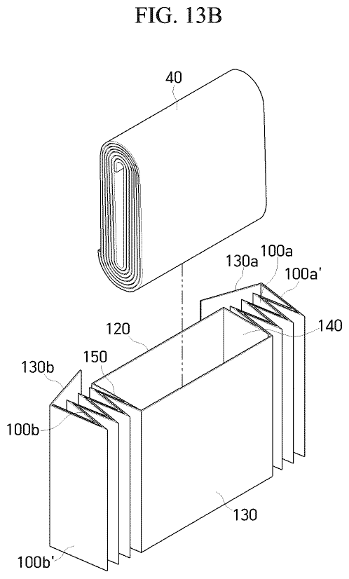

It should be noted in advance that the definitions of the positions of these faces are merely for convenience of explanation and understanding and do not indicate the absolute orientation of the electrode assembly 40. Moreover, FIG. 11 illustrates the electrode assembly 40 rotated in orientation by 90 degrees compared to the orientation of the electrode assembly 40 in FIGS. 9 and 13b, but the definitions of the positions of the faces thereof are still used in the same way.

The first, second, . . . , fifth faces of the electrode assembly 40 defined in FIGS. 9, 11, and 13b refer to a bottom, a back, a front, a right side, and a left side based on figures regardless of the orientation of the electrode assembly 40 inserted into the space defined by folding the internal insulation tape. Accordingly, the first face 11 refers to a narrow lying face located at the bottom of the electrode assembly 40, the second face 12 refers to a wide standing face located on the back of the electrode assembly 40, the third face 13 refers to a wide standing face located in the front of the electrode assembly 40, the fourth face 14 refers to a narrow standing face located on the right side of the electrode assembly 40, and the fifth face 15 refers to a narrow standing face located on the left side of the electrode assembly 40.

FIG. 8 is a plan view of an internal insulation tape including a buffer according to an embodiment of the present disclosure. FIG. 9 is a schematic view illustrating a state in which the insulation tape shown in FIG. 8 is applied to the electrode assembly 40.

The internal insulation tape according to this embodiment may have a first part 110 in contact with the first face 11 of the electrode assembly 40, a second part 120 in contact with the second face 12 of the electrode assembly 40, a third part 130 in contact with the third face 13 of the electrode assembly 40, a fourth part 140 in contact with the fourth face 14 of the electrode assembly 40, a fifth part 150 in contact with the fifth face 15 of the electrode assembly 40, a first buffer 100a connected to the fourth part 140 and in contact with the fourth face 14 of the electrode assembly 40, and a second buffer 100b connected to the fifth part 150 and in contact with the fifth face 15 of the electrode assembly 40.

The first part 110, the second part 120, the third part 130, the fourth part 140, and the fifth part 150 of the internal insulation tape may be folded along the dotted lines shown in FIG. 8 to wrap the five faces of the electrode assembly 40, excluding the upper face thereof, regardless of the orientation of the electrode assembly 40, as illustrated in FIG. 9. The first buffer 100a may be bent multiple times as mentioned above and located between the fourth face 14 of the electrode assembly 40 and the opposing surface of the case 51 to insulate and provide shock-absorbing functions. In addition, the second buffer 100b may be bent multiple times as mentioned above and located between the fifth face 15 of the electrode assembly 40 and the opposing surface of the case 51 to insulate and provide shock-absorbing functions.

The internal insulation tape may have an adhesive applied thereto and may be adhered to the electrode assembly 40, but the present disclosure is not limited thereto.

For example, the internal insulation tape may be applied with an adhesive to one surface thereof and adhered to the outer surface of the electrode assembly 40. For example, after the electrode assembly 40 is manufactured by winding or stacking a positive electrode plate, a negative electrode plate, and a separator, the electrode assembly 40 may be inserted into the case 51 with the internal insulation tape adhered to the outer surface of the electrode assembly 40.

As another example, the internal insulation tape may be in contact with the outer surface of the electrode assembly 40 without an adhesive. In such an embodiment, the manufactured electrode assembly 40 may be inserted into the case 51 with the internal insulation tape wrapping around the electrode assembly 40. In another embodiment, the internal insulation tape may first be inserted into the case 51 in a folded state, and then the electrode assembly 40 may be inserted into the internal space of the internal insulation tape, as illustrated in FIG. 9.

The number of bending times of each of the first and second buffers 100a and 100b may be determined by taking into account the gap (e.g., the size of the gap) between the inner surface of the case 51 and the opposing surface of the electrode assembly 40, the shock absorption capacity that varies with the size, weight, and purpose of the secondary battery, and so on. For example, a large gap between the inner surface of the case 51 and the opposing surface of the electrode assembly 40 may necessitate the buffer being bent more times. Additionally, because the secondary batteries used in large vehicles will experience greater impact, they may require buffers that are bent a relatively large number of times correspondingly. However, if the number of bending times of each buffer 100a or 100b increases excessively, the buffer will have a long lateral length, which may cause difficulties in process management and material management. According to experiments by the present inventor(s), the number of bending times of each of the first and second buffers 100a and 100a is preferably in a range from 3 to 20 times, but the present disclosure is not limited thereto. If the first and second buffers 100a and 100a is bent less than 3 times, the buffer may lack the ability to fill the gap between the inner surface of the case and the opposing surface of the electrode assembly, and if the first and second buffers 100a and 100a is bent more than 20 times, the buffer may be too length.

The first buffer 100a and the second buffer 100b may each have a bent (e.g., folded) part, which is folded at an acute angle as illustrated in FIG. 9 or is folded to form a gentle curve.

FIG. 10 is a plan view of an internal insulation tape including a buffer according to another embodiment of the present disclosure. FIG. 11 is a schematic view illustrating a state in which the shaped insulation tape shown in FIG. 10 is applied to the electrode assembly 40.

The internal insulation tape according to this embodiment may further include a sixth part 130a connected to the first buffer 100a and a seventh part 130b connected to the second buffer 100b, in addition to the parts illustrated and described with respect to FIG. 8. Both the sixth part 130a and the seventh part 130b may be in contact with the third part 130 as illustrated in FIG. 11.

The sixth part 130a and the seventh part 130b may further wrap the third face 13 of the electrode assembly 40 in addition to the third part 130, thereby reducing the possibility that the bent first and second buffers 100a and 100b are out of position, as well as making it easier to work when inserting the electrode assembly 40 into the case 51. For example, even if an adhesive is partially applied to only the sixth part 130a and the seventh part 130b without application of the adhesive to the internal insulation tape, the internal insulation tape may be fixed to the outer surface of the electrode assembly 40, which can improve workability and reduce adhesive application costs.

For reference, FIG. 11 illustrates that the orientation of the electrode assembly 40 to be inserted is different from that in FIG. 9 (and FIG. 13b). This is to show the possibility that the buffer of the present disclosure is employable (or functional) regardless of the orientation of the electrode assembly 40 to be inserted. When the electrode assembly 40 is inserted in a direction as illustrated in FIGS. 9 and 13b, the secondary battery have a side-tab structure. On the other hand, when the electrode assembly 40 is inserted in a direction as illustrated in FIG. 11, the secondary battery may have a top-tab structure.

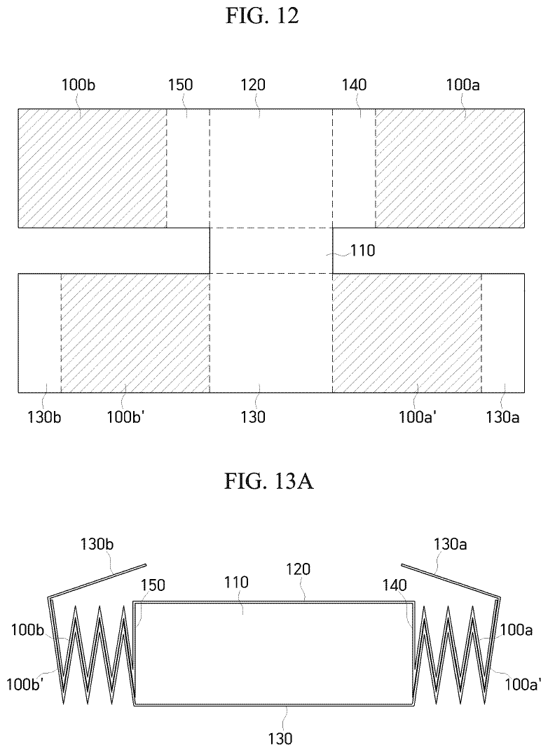

FIG. 12 is a plan view of an internal insulation tape including a buffer according to another embodiment of the present disclosure. FIGS. 13A and 13B are schematic views illustrating a state in which this shaped insulation tape is applied to the electrode assembly 40.

The internal insulation tape according to this embodiment may further include a third buffer 100a′ and a fourth buffer 100b′, which are connected to the third part 130, in addition to the parts described and illustrated with respect to FIG. 8. As illustrated in FIG. 13A, the third buffer 100a′ may overlap with the first buffer 100a and bent together therewith, and the fourth buffer 100b′ may overlap with the second buffer 100b and bent together therewith. This can double the shock-absorbing function (or ability) of the buffer. For example, a greater cushioning force may be provided compared to the same size by cooperation of the first buffer 100a and the third buffer 100a′ and cooperation of the second buffer 100b and the fourth buffer 100b′. On the other hand, the same shock-absorbing function can be accomplished even if the first buffer 100a and/or the second buffer 100b and the third buffer 100a′ and/or the fourth buffer 100b′ are decreased in length, resulting in an increase in process and management efficiency.

Similar to those illustrated in FIG. 10, the internal insulation tape may further include a sixth part 130a connected to the third buffer 100a′ and a seventh part 130b connected to the fourth buffer 100b′. Both the sixth part 130a and the seventh part 130b may be in contact with the second part 120 as illustrated in FIGS. 13A and 13B. Similar to the embodiment shown in FIG. 11, the sixth part 130a and the seventh part 130b may doubly wrap the second face 12 of the electrode assembly 40 together with the second part 120, thereby helping with the positional stability of the internal insulation tape. For example, even if the adhesive is partially applied only to the sixth part 130a and the seventh part 130b without application of an adhesive to the internal insulation tape, the internal insulation tape may be fixed to the outer surface of the electrode assembly 40, which can improve workability and reduce adhesive application costs.

Although the above-described embodiments have referred to an internal insulation tape having a shape corresponding to a prismatic secondary battery, the shock absorption with the internal insulation tape according to embodiments of the present disclosure may be applied to other types of secondary batteries, for example, a cylindrical or coin-type secondary battery. For example, the first buffer 100a or the second buffer 100b may be independently inserted between the electrode assembly and the can of the cylindrical or coin-type secondary battery. For example, after the internal insulation tape is manufactured to match the shape of the can of the cylindrical or coin-type secondary battery, a portion of the internal insulation tape may be bent to form the first buffer 100a or the second buffer 100b.

A method of manufacturing secondary batteries according to an embodiment of the present disclosure will now be briefly described.

First, a case for a secondary battery and an electrode assembly to be accommodated in the case may be manufactured. In addition, a first buffer 100a and a second buffer 100b may be manufactured. The first buffer 100a and the second buffer 100b may each be manufactured as an independent member by bending a film or plate multiple times.

Next, the manufactured electrode assembly is inserted into the case. In this case, the above-mentioned first buffer 100a and second buffer 100b are interposed in (e.g., are inserted into) the insert gaps G3 and G4 between the inner surfaces of the short sides 55a and 55b of the case and the opposing surfaces of the electrode assembly. To this end, according to some embodiments, the first buffer 100a and/or the second buffer 100b may be attached to the opposing surface(s) of the electrode assembly and they may be inserted into the case together therewith. According to some other embodiments, after the electrode assembly is inserted into the case, the first buffer 100a and/or the second buffer 100b may be fitted into the space(s) (e.g., insert gap(s)) between the electrode assembly and the case.

The subsequent process is the same as a typical method of manufacturing secondary batteries. For example, a cap plate may be welded to the case and sealed by injecting electrolyte.

Additionally, a method of manufacturing secondary batteries according to another embodiment of the present disclosure will be described.

In this embodiment, a first buffer 100a and a second buffer 100b may not be manufactured as independent members but may be manufactured to be included in an internal insulation tape as illustrated in FIGS. 8, 10, and 12.

In some embodiments, the manufactured internal insulation tape may be folded to wrap an electrode assembly. In such an embodiment, if an adhesive is applied to the internal insulation tape, the internal insulation tape may be adhered to the outer surface of the electrode assembly. If no adhesive is applied to the internal insulation tape, the internal insulation tape may simply wrap the electrode assembly. When the internal insulation tape wraps the electrode assembly, the first buffer 100a and the second buffer 100b may be repeatedly bent multiple times. The prepared electrode assembly and the internal insulation tape wrapping the electrode assembly are inserted into the case together.

In some other embodiments, the internal insulation tape may first be folded and inserted into the case. In such an embodiment, the internal insulation tape may be inserted into the case such that the first buffer 100a and the second buffer 100b included in the internal insulation tape are repeatedly bent multiple times and located in the insert gaps on the inner surfaces of the short sides of the case. The electrode assembly may then be inserted into the space defined by the internal insulation tape.

The subsequent process is the same as a typical method of manufacturing secondary batteries. For example, a cap plate may be welded to the case and sealed by injecting electrolyte.

Hereinafter, materials that may be usable for the secondary battery according to the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0≤α≤2); LiₐNi_{b}CO_{c}L¹_{d}GeO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiaCoGbO2 (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li (3-f) Fe2 (PO₄) 3 (0sf≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

In some examples, the content of the positive electrode active material may be in a range of about 90 wt % to about 99.5 wt % on the basis of 100 wt % of the positive electrode active material layer, and the content of the binder and the conductive material may be in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, a transition metal oxide, and/or the like.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent, a lithium salt, and/or the like.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). The separator may include polyethylene, polypropylene, polyvinylidene fluoride, or a multilayer film of two or more layers thereof.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

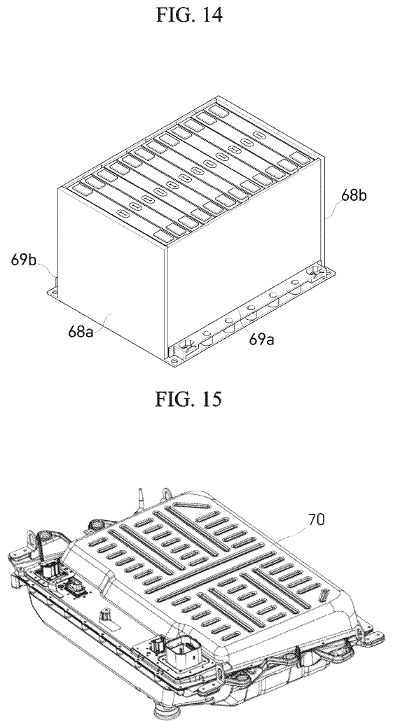

FIG. 14 is a perspective view of a secondary battery module in which prismatic secondary batteries are arranged according to some embodiments of the present disclosure. With the increased in secondary battery capacity for driving electric vehicles or the like, a secondary battery module may be manufactured by arranging and connecting togethera plurality of secondary battery cells transversely and/or longitudinally. The plurality of secondary batteries may be arranged in a space defined by a pair of facing end plates 68a and 68b and a pair of facing side plates 69a and 69b. The secondary batteries may be arranged in a suitable arrangement (e.g., direction) and number to obtain desired voltage and current capabilities.

FIG. 15 is a view schematically showing the configuration of a battery pack 70 according to some embodiments of the present disclosure. Referring to FIG. 15, a battery pack 70 may include an assembly to which individual batteries are electrically connected and a pack housing accommodating the same. In the drawings, for convenience of illustration, components including a bus bar, a cooling unit, external terminals for electrically connecting batteries, etc., are not shown.

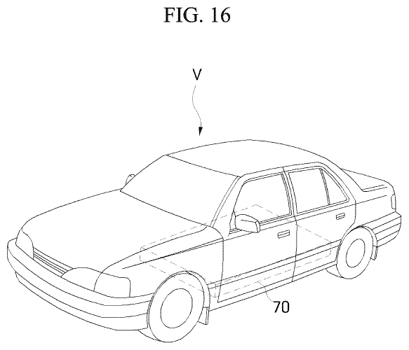

The battery pack 70 may be mounted on (or in) a vehicle. The vehicle may be, for example, an electric vehicle, a hybrid vehicle, or a plug-in hybrid vehicle. The vehicle may be a four-wheeled vehicle or a two-wheeled vehicle but is not limited thereto. FIG. 16 shows a vehicle V that includes the battery pack 70 shown in FIG. 15 on the lower body thereof. The vehicle V may operate by (e.g., may be powered by) receiving power from the battery pack 70.

The side retainer of a conventional secondary battery is made of a solid material, and the insert gap is present for insertion of the electrode assembly during manufacturing of the secondary battery. Hence, according to embodiments of the present disclosure, an insulating buffer in the form of a film or a plate may be bent multiple times into a wrinkled shape and interposed in the insert gap, thereby enabling insulation and shock absorption to be accomplished in place of the conventional side retainer.

Additionally, by manufacturing the buffer as a portion of the internal insulation tape to fill the insert gap, both an insulating function and a shock-absorbing function may be provided on the outer surface of the electrode assembly. Thus, any vibration or shock applied to the secondary battery case can be elasticity absorbed by repeatedly bending a portion of the internal insulation tape.

In addition, because the amount of material used is small compared to the side retainer, the possibility of blocking the flow path of gas even if the buffer melts or burns in case of a battery event is greatly reduced.

The buffer according to embodiments of the present disclosure may be applied to prismatic, cylindrical, and coin-type secondary batteries.

Although the present disclosure has been described above with respect to some embodiments thereof, the present disclosure is not limited thereto. Various suitable modifications and variations can be made thereto by those skilled in the art within the spirit of the present disclosure, the scope of which is define by the following claims and the equivalents thereof.

What is claimed is:

1. A secondary battery comprising:
an electrode assembly;
a case accommodating the electrode assembly therein; and
a buffer arranged between the electrode assembly and the case and repeatedly bent a plurality of times.

2. The secondary battery according to claim 1, wherein the buffer comprises:
a first buffer arranged in a first insert gap between a first short side of the case and the electrode assembly; and
a second buffer arranged in a second insert gap between a second short side of the case and the electrode assembly.

3. The secondary battery according to claim 1, wherein the buffer comprises a material selected from polymer material, synthetic resin, paper, synthetic fiber, and natural fiber.

4. The secondary battery according to claim 1, wherein the buffer is part of an internal insulation tape wrapped around the electrode assembly.

5. The secondary battery according to claim 4, wherein the internal insulation tape has parts in contact with faces of the electrode assembly facing inner surfaces of first and second long sides of the case.

6. The secondary battery according to claim 4, wherein the internal insulation tape has a part in contact with a face of the electrode assembly facing an inner surface of a bottom of the case.

7. The secondary battery according to claim 4, wherein the internal insulation tape further comprises an adhesive applied to its surface for adhesion to the electrode assembly.

8. The secondary battery according to claim 4, wherein the internal insulation tape has:
a first part in contact with a first face of the electrode assembly;
a second part in contact with a second face of the electrode assembly;
a third part in contact with a third face of the electrode assembly;
a fourth part in contact with a fourth face of the electrode assembly;
a fifth part in contact with a fifth face of the electrode assembly;
a first buffer connected to the fourth part, the first buffer being in contact with the fourth face of the electrode assembly and repeatedly bent a plurality of times; and
a second buffer connected to the fifth part, the second buffer being in contact with the fifth face of the electrode assembly and repeatedly bent a plurality of times.

9. The secondary battery according to claim 8, wherein the internal insulation tape has:
a sixth part connected to the first buffer; and
a seventh part connected to the second buffer, and
wherein the sixth part and the seventh part are in contact with the third part.

10. The secondary battery according to claim 8, wherein the internal insulation tape has a third buffer and a fourth buffer, both of which are connected to the third part,
wherein the third buffer overlaps the first buffer and is bent therewith, and
wherein the fourth buffer overlaps the second buffer and is bent therewith.

11. The secondary battery according to claim 10, wherein the internal insulation tape has:
a sixth part connected to the third buffer; and
a seventh part connected to the fourth buffer, and
wherein the sixth part and the seventh part are in contact with the second part.

12. A method of manufacturing a secondary battery, the method comprising:
forming a buffer by repeatedly bending a non-conductive material a plurality of times to; and
inserting an electrode assembly into a case and arranging the buffer in an insert gap between an inner surface of a short side of the case and an opposing surface of the electrode assembly.

13. The method according to claim 12, wherein the inserting of the electrode assembly into the case comprises attaching the buffer to the opposing surface of the electrode assembly and inserting the buffer and the electrode assembly into the case together.

14. The method according to claim 12, wherein the inserting of the electrode assembly into the case comprises arranging the buffer in a space between the electrode assembly and the case after inserting the electrode assembly into the case.

15. The method according to claim 12, wherein the forming of the buffer comprises repeatedly bending, a plurality of times, a portion of an internal insulation tape that is configured to be wrapped around the electrode assembly times, and
wherein the inserting of the electrode assembly into the case comprises wrapping the electrode assembly with the internal insulation tape comprising the buffer and inserting the electrode assembly into the case.

16. The method according to claim 12, wherein the forming of the buffer comprises repeatedly bending, a plurality of times, a portion of an internal insulation tape configured to be wrapped around the electrode assembly, and
wherein the inserting of the electrode assembly into the case comprises inserting the internal insulation tape comprising the buffer into the case and then inserting the electrode assembly into a space defined by the internal insulation tape.

17. An internal insulation tape for secondary batteries configured to be wrapped around an electrode assembly and accommodated in a case of a secondary battery comprises a buffer between the electrode assembly and the case that is repeatedly bent a plurality of times.

18. The internal insulation tape according to claim 17, wherein the buffer comprises:
a first buffer in a first insert gap between a first short side of the case and the electrode assembly and repeatedly bent a plurality of times; and
a second buffer located in a second insert gap between a second short side of the case and the electrode assembly and repeatedly bent a plurality of times.

19. The internal insulation tape according to claim 18, wherein the buffer further comprises:
a third buffer overlapped with the first buffer and repeatedly bent a plurality of times; and
a fourth buffer overlapped with the second buffer and repeatedly bent a plurality of times.

20. The internal insulation tape according to claim 17, wherein the internal insulation tape further comprises an adhesive applied to its surface for adhesion to the electrode assembly.
